(19) United States
(12) Patent Application Publication
(10) Pub. No.: US 2019/0384466 A1
(43) Pub. Date: Dec. 19, 2019

(54) LINKING COMMENTS TO SEGMENTS OF A MEDIA PRESENTATION

(71) Applicant: International Business Machines Corporation, Armonk, NY (US)

(72) Inventors: Fang Lu, Billerica, MA (US); Paul R. Bastide, Boxford, MA (US); Robert E. Loredo, North Miami Beach, FL (US); Matthew E. Broomhall, Goffstown, NH (US)

(21) Appl. No.: 16/007,137

(22) Filed: Jun. 13, 2018

(51) Int. Cl. G06F 3/0484; G06F 17/27; G10L 15/26; G06K 9/00

(52) U.S. Cl. CPC G06F 3/0484; G06K 9/00718; G10L 15/265; G06F 17/2785

(57) ABSTRACT

Key content of a plurality of segments of a media presentation can be identified by analyzing the plurality of segments of the media presentation. Comments pertaining to the media presentation can be scanned, and to which of the plurality of segments of the media presentation each comment pertains can be determined. Links between the comments and particular segments of the media presentation to which the comments are directed can be created, wherein the links are user selectable to jump to the particular segments of the media presentation. The comments with the links to the particular segments of the media presentation to which the comments are directed can be presented in a user interface presented on a display.

### BACKGROUND

The present invention relates to media presentations, and more specifically, to facilitating user navigation of media presentations.

Media presentations typically include audio and/or video, though sometimes media presentations also may include still images and/or text. With the proliferation of the Internet in recent decades, users can download and/or stream media presentations from a variety of sources and to a variety of devices, including televisions, desktop computers, mobile computers, tablet computers, smart phones, etc. Indeed, media presentations oftentimes are presented to users on demand, allowing users to view and/or listen to the media presentations on devices, and at times, that are convenient for the users.

### SUMMARY

A method includes identifying key content of a plurality of segments of a media presentation by analyzing the plurality of segments of the media presentation. The method also can include scanning comments pertaining to the media presentation, and determining to which of the plurality of segments of the media presentation each comment pertains. The method also can include creating, using a processor, links between the comments and particular segments of the media presentation to which the comments are directed, wherein the links are user selectable to jump to the particular segments of the media presentation. The method also can include, presenting, in a user interface presented on a display, the comments with the links to the particular segments of the media presentation to which the comments are directed.

A system includes a processor programmed to initiate executable operations. The executable operations include identifying key content of a plurality of segments of a media presentation by analyzing the plurality of segments of the media presentation. The executable operations also can include scanning comments pertaining to the media presentation, and determining to which of the plurality of segments of the media presentation each comment pertains. The executable operations also can include creating links between the comments and particular segments of the media presentation to which the comments are directed, wherein the links are user selectable to jump to the particular segments of the media presentation. The executable operations also can include, presenting, in a user interface presented on a display, the comments with the links to the particular segments of the media presentation to which the comments are directed.

A computer program product includes a computer readable storage medium having program code stored thereon. The program code is executable by a data processing system to initiate operations. The operations include identifying key content of a plurality of segments of a media presentation by analyzing the plurality of segments of the media presentation. The operations also can include scanning comments pertaining to the media presentation, and determining to which of the plurality of segments of the media presentation each comment pertains. The operations also can include creating links between the comments and particular segments of the media presentation to which the comments are directed, wherein the links are user selectable to jump to the particular segments of the media presentation. The operations also can include, presenting, in a user interface presented on a display, the comments with the links to the particular segments of the media presentation to which the comments are directed.

### BRIEF DESCRIPTION OF THE DRAWINGS

FIG. 1 is a block diagram illustrating example architecture for a content presentation and navigation system.

FIG. 2 depicts a view of an example user interface for presenting a media presentation and comments with links to particular segments of the media presentation.

FIG. 3 is a flowchart illustrating an example of a method of presenting comments with links to particular segments of a media presentation.

FIG. 4 is a flowchart illustrating an example of processing of a new user comment pertaining to a media presentation.

FIG. 5 is a block diagram illustrating an example of a media presentation environment.

FIG. 6 is a block diagram illustrating example architecture for a server.

FIG. 7 is a block diagram illustrating example architecture for a client device.

### DETAILED DESCRIPTION

This disclosure relates to media presentations and, more particularly, to facilitating navigation of media presentations. In accordance with the inventive arrangements disclosed herein, a media navigation model can be generated for a media presentation. The media navigation model can include or identify user comments directed to the media presentation, as well as links from the user comments to particular segments of the media presentation to which the user comments pertain. The media navigation model 160 can be processed by a system to present, in a user interface, the user comments and the links to the particular segments of the media presentation. For example, the user can select a particular comment, and the system can jump playback of the media presentation to the particular segment to which the comment pertains. Further, the user can input queries to the system pertaining to an aspect of the media presentation, and the system can jump playback of the media presentation to a segment of the media presentation pertaining to that aspect. Accordingly, the present arrangements provide an improved user interface that facilitates use of the system by a user in order to navigate the media presentation.

Several definitions that apply throughout this document now will be presented.

As defined herein, the term “media presentation” means content that may be streamed to, or downloaded to, one or more client devices, the content comprising audio, video, text and/or still images.

As defined herein, the term “live presentation” means a media presentation that is streamed to one or more client devices in real time as the media presentation is being presented live.

As defined herein, the term “segment” means a portion of a media presentation that is less than the entire media presentation, wherein the media presentation comprises a plurality of portions. A segment can be, for example, a portion of a media presentation in which a particular song is played, a portion of a media presentation in which a particular scene is displayed, a portion of a media presentation in which a particular slide, or a plurality of related slides, are presented, a portion of a media presentation in which a particular presenter is presenting content, etc.

As defined herein, the term “keyframe” means a location on a timeline in a media presentation that marks the beginning or end of a transition, for example the beginning or end of a segment of a multimedia presentation. Keyframes also may be used to mark a middle of a segment.

As defined herein, the term “key content” means content presented in a segment of a media presentation that is a focus of the segment.

As defined herein, the term “comment” means text, one or more spoken utterances, one or more emojis and/or one or more emoticons provided by a user to whom a media presentation is presented that pertain(s) to the media presentation.

As defined herein, the term “jump” means to immediately move to a particular portion of a media presentation, for example to immediately move backward or forward from one portion of a media presentation to another portion of the media presentation, skipping portions of the media presentation between the portion being moved from and the portion being moved to.

As defined herein, the term “emoji” means a digital image or icon used in electronic communications to express a feeling, emotion or an intended tone. Emoji's typically are small (i.e., no greater than a threshold size).

As defined herein, the term “emoticon” means a combination of two or more characters (e.g., keyboard or keypad characters) used in electronic communications to express a feeling, emotion or an intended tone, for example by emulating a facial expression with the characters.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “server” means a data processing system configured to share services with one or more other data processing systems.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

As defined herein, the term “user” means a person (i.e., a human being).

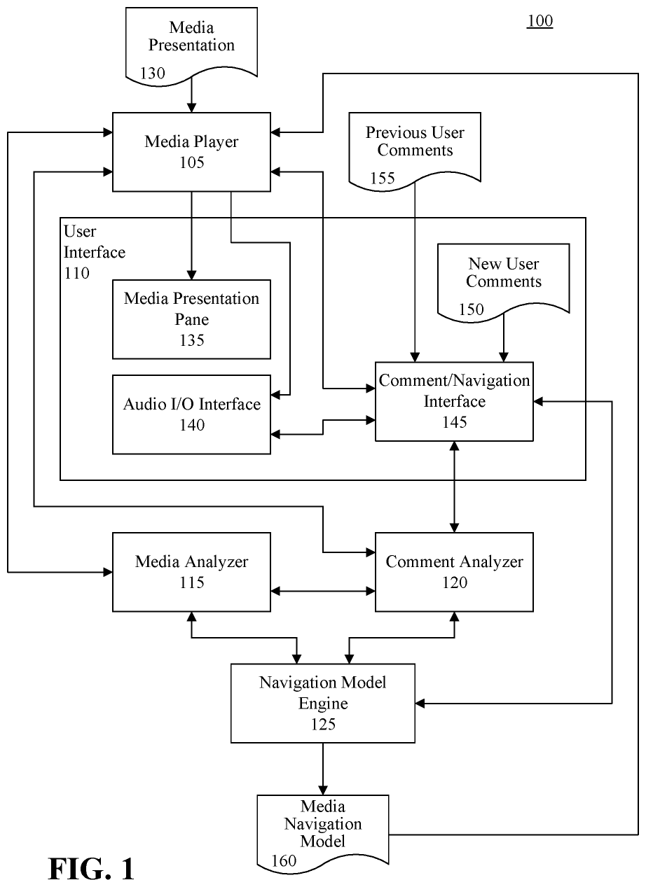

FIG. 1 is a block diagram illustrating example architecture for a media presentation and navigation system (hereinafter “system”) 100. The system 100 can include a media player 105, a user interface 110, a media analyzer 115, a comment analyzer 120, and a navigation model engine 125. The media player 105 can be configured to receive media presentations, such as a media presentation 130, and present the media presentations to users via the user interface 110. In illustration, the media player 105 can present images, video and/or text of the media presentation 130 via a media presentation pane 135 of the user interface 110. Further, the media player 105 can present audio of the media presentation 130 via an audio input/output (I/O) interface 140 of the user interface 110. The audio I/O interface 140 can, for example, but communicatively linked to audio I/O components of a data processing system (e.g., a client device) via which the user interface 110 is presented to a user.

The user interface 110 further can present a comment/navigation interface 145. The comment/navigation interface 145 can be configured to receive new comments 150 from a user and present previous user comments 155 received from the user and/or other users. The comments 150, 155 can include text and/or emojis. The text can be received via user inputs into a keyboard, a keypad, a virtual keyboard, a virtual keypad, buttons, etc. Further, spoken utterances generated by a user can be received via the audio I/O interface 140, which can perform speech recognition to generate the text using techniques well known in the art.

The comment/navigation interface 145 also can be configured to receive navigation selections from the user to navigate the media presentation 130. In response to the navigation selections, the comment/navigation interface 145 can communicate corresponding navigation commands to the media player 105. In response to the navigation commands, the media player 105 can change playback of the media presentation, e.g., pause, play, fast forward, rewind and/or jump to a particular segment of the media presentation. As will be described in further detail, the navigation selections can include selections by the user of previous user comments 155 which are linked to particular segments of the media presentation 130, for example to keyframes in the segments. In illustration, in response to a user selecting a previous user comment 155, the media player 105 can jump to a particular segment of the media presentation 130 with which the user comment 155 has been linked in a media navigation model 160 generated by the navigation model engine 125. For instance, the media player 105 can jump to a keyframe of the segment. In another arrangement, the media player 105 can jump to a frame in the segment that was being presented to a particular user when that user provided a comment 155 pertaining to the media presentation 130. In another arrangement, if a comment 155 indicates “the last 2 minutes of the presentation are very important,” in response to a user selecting that comment 155, the media player 105 can jump to a frame in the media presentation 130 that was being presented two minutes before the comment 155 was provided.

The media analyzer 115 can be configured to identify key content of a plurality of segments of a media presentation 130. For example, the media analyzer 115 can analyze the media presentation 130 to identify a plurality of segments in the media presentation 130, and identify key content presented in those segments. Further, the media analyzer 115 can identify keyframes of the segments. A keyframe can be, for example, a location in a time line at the beginning of a segment (e.g., at a first frame of the segment), a location in the time line at the end of a segment (e.g., at a last frame of the segment), or at a location in the time line between the beginning of the segment and the end of the segment. In illustration, the media analyzer 115 can identify and analyze text, audio, still images and video in the media presentation 130. The media analyzer 115 can store results of such analyses in one or more suitable functional data structures, for example data tables contained in a database. The results can include time stamps indicating where/when, in the media presentation 130, the segments and keyframes are located, as well as time stamps indicating when various segments and/or keyframes of the media presentation 130 are presented to various users. In illustration, for each user to whom the media presentation 130 is presented, the media analyzer 115 can communicate with the media player 105 to determine when each segment and/or keyframe is presented to the user via the user interface 110.

As part of the analysis, the media analyzer 115 can perform speech recognition on spoken utterances contained in the audio and generate corresponding text. The media analyzer 115 also can perform optical character recognition (OCR) on text contained in the media presentation 130 presented as image objects and not otherwise stored in the media presentation 130 in a text format (e.g., Rich Text Format (RTF), American Standard Code for Information Interchange (ASCII), etc.). Further, the media analyzer 115 can perform natural language processing (NLP) and semantic analysis on text contained in the media presentation 130 and text generated from the NLP. NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) (e.g., ISO/TC37/SC4) publishes standards for NLP. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input. An unstructured information management architecture (UIMA), which is an industry standard for content analytics, may be used by the media analyzer 115 to implement NLP and semantic analysis.

As part of the analysis, the media analyzer 115 also can perform image analysis on still images and video contained in the media presentation 130 to generate a computer-understandable meaning of each segment and/or keyframe containing images and/or video. Image analysis is the extraction of meaningful information from images, for example using digital imaging processing techniques. Examples of such image processing techniques may include, but are not limited to, two-dimensional object recognition, three-dimensional object recognition, image segmentation, motion detection, video tracking, optical flow, three-dimensional pose estimation, and on.

The comment analyzer 120 can scan and analyze comments 150, 155 pertaining to the media presentation. The comments 150, 155 can include, for example spoken utterances, text, emoticons and/or emojis. The comment analyzer 120 can store results of analyzing the comments 150, 155 to a functional data structure, for example a data table in a database. The analysis can include identifying time stamps indicating when the comments 150, 155 were/are generated and who generated the comments 150, 155. As part of the analysis, the comment analyzer 120 can perform speech recognition on spoken utterances contained in the comments 150, 155 and generate corresponding text. The comment analyzer 120 also can perform NLP and semantic analysis on both text contained in the comments and text generated by the speech recognition. The NLP and semantic analysis can derive computer-understandable meaning of the comments 150, 155.

Further, the comment analyzer 120 can analyze emoticons and emojis and determine a meaning of each of the emoticons and emojis. In illustration, the comment analyzer 120 can access a data table containing records indicating the meaning of various emoticons, and determine the meaning of emoticons by querying the data table with a query containing a subject emoticon. Similarly, the comment analyzer 120 can access a data table containing records indicating the meaning of various emojis, and determine the meaning of emoticons by querying the data table with queries containing subject emojis (or identifiers assigned to the subject emojis). In a further arrangement, the comment analyzer 120 can perform image analyses on emoji images and determine the meaning of the emojis based on the image analyses. In illustration, if an emoji is an image of a happy face or a hand with a thumb pointing upward, the comment analyzer 120 can determine that the emoji indicates “like” and/or “approval.” If, however, an emoji is an image of a sad face or a hand with a thumb pointing downward, the comment analyzer 120 can determine that the emoji indicates “dislike” and/or “disapproval.” Still, there are a myriad of other meanings which can be conveyed with emojis, and the present arrangements are not limited in this regard.

The navigation model engine 125 can determine to which of the plurality of segments of the media presentation 130 each comment 150, 155 is directed. In illustration, the navigation model engine 125 can identify the time stamp of a comment 150, 155 and identify a corresponding time stamp indicating when a particular segment and/or keyframe of the media presentation 130 is/was presented to the user who generated the comment 150, 155. Based on the time stamps, the navigation model engine 125 can determine that the comment 150, 155 is directed to the identified segment and/or keyframe. The time stamps need not match precisely, however. For instance, the identified segment and/or keyframe can be a segment and/or keyframe having a time stamp which most closely precedes the time stamp of the comment 150, 155.

In a further arrangement, the navigation model engine 125 can compare the derived computer computer-understandable meaning of the comments 150, 155 to the derived computer-understandable meaning of various segments and/or keyframes of the media presentation 130 to determine to which segment(s) and/or keyframe(s) each comment 150, 155 is directed. In illustration, if the media presentation 130 contains a segment in which the song “Swan Lake” is played, and a comment 150, 155 indicates “I love this rendition of Swan Lake,” the navigation model engine 125 can determine that the comment corresponds to that segment. Further, based on use of the term “love” in the comment 150, 155, the comment analyzer 120 can categorize the comment 150, 155 as expressing a positive sentiment toward that segment of the media presentation 130, and the navigation model engine 125 can categorize the comment 150, 155 accordingly (e.g., as a like or positive sentiment). In another example, if the media presentation 130 contains a segment containing an image of a red car, and the comment 150, 155 indicates “I do not like the red car,” the navigation model engine 125 can determine that the comment corresponds to that segment. Further, based on use of the term “do not like” in the comment 150, 155, the comment analyzer 120 can categorize the comment 150, 155 as expressing a negative sentiment toward that segment of the media presentation 130, and the navigation model engine 125 can categorize the comment 150, 155 accordingly (e.g., as a dislike or negative sentiment).

Further, based on the results of the NLP and semantic analyses performed by the comment analyzer 120 on the comments 150, 155, the navigation model engine 125 can identify reasoning for user sentiments toward segments of the media presentation 130 to which the comments are directed. For instance, one or more comments 150, 155 may include text expressing reasons why users have indicated a positive or negative sentiment toward a segment of the media presentation 130, which may be included in the results of the NLP and semantic analyses performed by the comment analyzer 120. The navigation model engine 125 can identify the expressions of the reasons in the results, and generalize such reasons. The navigation model engine 125 can generalize the reasons by identifying the same terms and/or synonyms in various comments 150, 155, identifying comments 150, 155 expressing the same or similar sentiments, and creating one or more grammatically correct sentences using the terms and/or synonyms. To do so, the navigation model engine 125 can access one or more electronic dictionaries, electronic thesauruses, grammar applications and/or artificial intelligence (AI) applications. The navigation model engine 125 can add such sentence(s) to the media navigation model 160 and associate the sentence(s) with the comments 150, 155 that are being generalized. For instance, the media navigation model 160 can assign one or more identifiers to the sentence(s), and add such indenter(s) to data table records containing data for the subject comments 150, 155. The comment/navigation interface 145 can present the sentence(s) with one or more of the comments 150, 155 for which the reasoning is generalized by the sentence(s). For instance, the comment/navigation interface 145 can include the sentence(s) with a grouping of comments 150, 155 that includes the comments 150, 155 based on their assigned categories, which will be further explained.

In a further arrangement, the navigation model engine 125 also can interface with an AI system, for example IBM Watson®, to create a grammatically correct sentence using the terms and/or synonyms. In illustration, the navigation model engine 125 can communicate to the AI system the comments 150, 155 identified by the comment analyzer 120 as expressing the same or similar sentiments, as well as terms identified as being the same terms or synonyms, with a request that the AI system generate one or more sentences generalizing the content of the comments 150, 155. In response, the AI system can generate the sentence(s) and communicate the sentence(s) to the navigation model engine 125. The navigation model engine 125 can present such sentence(s), for example as previously described.

The navigation model engine 125 can create links between the comments and the particular segments of the media presentation 130 to which the comments 150, 155 are directed. In illustration, the navigation model engine 125 can create the media navigation model 160 based on the analysis of the media presentation by the media analyzer 115 and the analysis of the comments 150, 155 by the comment analyzer 120. The navigation model engine 125 can communicate the media navigation model 160 to the media player 105, which can communicate the media navigation model to the user interface 110 110, for example to the comment/navigation interface 145. In another arrangement, the navigation model engine 125 can communicate the media navigation model 160 directly to the comment/navigation interface 145.

In accordance with the media navigation model 160, the comment/navigation interface 145 can present in the user interface 110 the comments 155 with links to the segments (e.g., keyframes) of the media presentation 130 to which the comments pertain. In one arrangement, the comments 155 with the links can be presented to the user by default responsive to the user accessing the media presentation 130. In another arrangement, the comments 155 with the links can be presented in response to the user selecting a particular menu item, button, icon, etc., or in response to the user otherwise requesting insights on the media presentation 130 (e.g., entering a new user comment 150 requesting insights). Via real time updates to the media navigation model 160, which will be described in further detail, the comment/navigation interface 145 can present, in real time, new user comments 150 pertaining the media presentation 130 entered by the user and other users while the user is viewing and/or listing to the media presentation 130. Links also can be provided for the new user comments 150. In one aspect, certain user comments 150, 155 need not be included in the media navigation model 160, and thus not presented to the user, for example user comments 150, 155 requesting insights or asking questions relating to where content is presented in the media presentation 130. The navigation model engine 125 can identify such types of user comments 150, 155 based on results of the analysis performed by the comment analyzer 120 and process the comments 150, 155 to perform the requested actions and/or answer the questions being asked, but need not add the comments 150, 155 to the media navigation model 160.

The media navigation model 160 can include an identifier that identifies each of the comments 150, 155 pertaining to the media presentation 130, or can include the actual comments 150, 155. The media navigation model 160 also can include a respective link assigned by the navigation model engine 125 to each comment 150, 155. Each link can link the respective comment 150, 155 to the segment of the media presentation 130 to which the comment 150, 155 pertains. For example, each link can link to a keyframe in in the segment, a frame in the middle of the segment, a frame presented in the media presentation 130 when the comment was provided by the comment's author, or a frame corresponding to information provided in the comment. For instance, if a comment indicates “I really like the last 10 minutes of this concert,” the link can link to a frame presented in the media presentation 130 ten minutes prior to the comment being provided. The links can be user selectable to jump to the particular segments of the media presentation, for example to set or reset playback of the media presentation 130 by the media player 105 to begin at frames to which the comments are linked.

The links also can enable a user to navigate to a plurality of the segments or keyframes associated with the similar comments or similarly categorized comments, or skip the plurality of the keyframes associated with the similar comments or similarly categorized comments. In illustration, assume there is a first set of a plurality of previous user comments 155 categorized as indicating a positive sentiment for respective segments of the media presentation 130. Also assume there is a second set of a plurality of previous user comments 155 categorized as indicating a negative sentiment for other respective segments of the media presentation 130. The navigation model engine 125 can create in the media navigation model 160 a first comment group that includes the first set of the previous user comments 155 and a second comment group that includes the second set of the previous user comments 155. Further, the navigation model engine 125 can create in the media navigation model 160 groups of comments that include terms that are synonyms of one another. The comment/navigation interface 145 can present the previous user comments 155 to the user in their respective groupings. In one arrangement, the navigation model engine 125 or the comment/navigation interface 145 can apply color codes to the previous user comments 155 to indicate their respective groupings. For instance, comments in the first group can be indicated in a first color, comments in the second group can be indicated in a second color, and so on. This can serve to make it very easy for the user to identify which comments are related to one another.

Responsive to a user selecting a comment 155 from the first set, the comment/navigation interface 145 can access the media navigation model 160, from the media navigation model 160, identify a link assigned to the selected comment 155, and instruct the media player 105 to play the media presentation 130 beginning at the link assigned to the selected comment 155, for example a keyframe in the segment. Responsive to completion of playback of the segment, the comment/navigation interface 145 can identify a next comment 155 in the first set and, using a link assigned to the next comment 155 by the media navigation model 160, the comment/navigation interface 145 can instruct the media player 105 to play the media presentation 130 beginning at the link assigned to the next comment 155, and so on. During such process, the comment/navigation interface 145 can skip segments for which comments 155 in the second set are provided links. Accordingly, the system 100 can improve the user's experience viewing the media presentation 130 by automatically playing segments of the media presentation 130 for which other users have expressed a positive sentiment and skipping segments of the media presentation 130 for which other users have expressed a negative sentiment.

In some cases, there may be user comments 155 in both the first set and the second set assigned to a particular segment. The navigation model engine 125 (or comment/navigation interface 145) can be configured to assign a weighting to each of the comments, for example a positive number for positive comments and a negative number for negative comments, and average the numbers for comments 155 assigned to a particular segment to generate an average value. If the average value is greater than zero, the comment/navigation interface 145 can include that segment in a list of segments that are played by the media player 105. If the average value is less than or equal to zero, the comment/navigation interface 145 can exclude that segment in the list of segments that are played by the media player 105. The weighting assigned to each comment 155 can be determined based on the derived computer-understandable meaning of the comment 155 and/or a value assigned to an emoji or emoticon contained in the comment 155. For instance, based on the derived computer-understandable meaning of the comment 155, the navigation model engine 125 can assign a value to the comment (e.g., between −10 and 10), wherein negative values indicate a severity of a negative comment 155 and positive values indicate a severity of a positive comment 155. Further, an emoji that is a laughing face can be assigned a higher positive value (e.g., 8) than a value (e.g., 5) assigned an emoji that is a smiling face. Similarly, an emoji that is a mad face can be assigned a value (e.g., −9) that is more negative than a value (e.g., −5) assigned to an emoji that is a sad face.

In one aspect of the present arrangements, the navigation model can be overlaid onto a navigation component for the media presentation 130. In illustration, the media player 105 can present in the media presentation pane 135 a navigation bar presenting a timeline for the media presentation which can be used by a user to navigate the media presentation 130. The media player 105 can present with the navigation bar graphical navigation markers that indicate points of shift between positive and negative sentiments toward the media presentation 130. A point can be, for example, at a keyframe at the beginning of a segment. The media player 105 also can present an indicator, for example an icon or emoji, with each navigation marker to indicate whether the shift indicated by the navigation marker is a shift to a positive sentiment or a shift to a negative sentiment. For instance, if one or more comments 155 indicate a positive sentiment toward a first segment of the media presentation 130, the media player 105 can present an icon or emoji indicating the positive sentiment at or near the beginning of the first segment in the navigation bar. If one or more comments 155 indicate a negative sentiment toward a third segment of the media presentation 130, the media player 105 can present an icon or emoji indicating the negative sentiment at or near the beginning of the third segment in the navigation bar, and so on. The user can select the icons or emojis indicating the sentiments to jump to the respective segments of the media presentation 130 with which the icons or emojis are presented. In illustration, the user may want to only view portions of the media presentation 130 to which the user comments 155 indicate a positive sentiment. The user can select the navigation markers or the icons/emojis to jump to those portions of the media presentation 130.

While the media presentation 130 is presented to the user, the user may add a new user comment 155, for example if the user is watching a live stream of the media presentation 130. The comment analyzer 120 can analyze the new user comment 150 in real time and communicate, in real time, results of the analysis to the navigation model engine 125. The navigation model engine 125 can create, in real time, create a link between the new user comment 150 and the segment (e.g., keyframe in the segment) to which the new user comment 150 pertains. In doing so, the navigation model engine 125 can instruct the media analyzer 115 to perform a new analysis to identify the segment to which the new user comment 150 pertains, for example as previously described. In the case that the media presentation 130 has been pre-recorded, the navigation model engine 125 can access results of a previous analysis performed on the media presentation 130, but also may instruct the media analyzer 115 to perform a new analysis to identify the segment to which the new user comment 150 pertains if the use of the previous analysis does not identify the segment with at least a threshold level of confidence.

The navigation model engine 125 also can categorize the new user comment 150, for example as previously described. In the case that the new user comment 150 is the first user comment received by the system 100 for the media presentation 130, the navigation model engine 125 can generate a media navigation model 160 for the media presentation 130 based on the new user comment 150. As additional new user comments 150 are received from the user or other users, the media navigation model 160 can update the media navigation model 160 with links and/or categorizations for the additional new user comments 150.

In some cases, a new comment 150 may not be a specific comment on the media presentation 130, but instead may ask a question pertaining to the media presentation 130 or provide a navigation instruction. For example, the comment may ask “Has The Magic Flute already played?” or the comment may state “jump to the The Magic Flute.” The comment analyzer 120 can analyze the comment 150 using NLP and semantic analysis. Based on such analyses, the comment analyzer 120 can determine that the comment is a question or navigation instruction pertaining to the media presentation 130, and determine a context of the question or instruction. The comment analyzer 120 can communicate results of such analysis to the navigation model engine 125. The navigation model engine 125 can access results of a previous analysis of the media presentation 130 performed by the media analyzer 115 and/or instruct the media analyzer 115 to perform a new analysis to specifically identify one or more segments and/or keyframes of the media presentation 130 to which the question or instruction pertains. For example, the analysis can search the media presentation 130 to determine whether The Magic Flute has already played and, if so, in which segment of the media presentation 130 it was played. If The Magic Flute has already played, the navigation model engine 125 can update the media navigation model 160 with the comment 150 asking the question or providing the instruction, and a link between the comment 150 and the segment of the presentation where the song is played. For instance, the link can be to a keyframe in the presentation where the song begins. Responsive to the media navigation model 160 being updated, the comment/navigation interface 145 can present the link to the particular segment of the media presentation to which new comment 150 pertains.

In one arrangement, the media player 105 can monitor the media navigation model 160 to detect when the media navigation model 160 is updated, for example by monitoring changes to one or more data tables containing the data for the media navigation model 160, and communicate such updates (or the entire updated media navigation model 160) to the comment/navigation interface 145. In another arrangement, the media navigation model 160 can communicate such updates (or the entire updated media navigation model 160) directly to the comment/navigation interface 145. In any case, the comment/navigation interface 145 can present to the user a link to the segment (e.g., keyframe) in which the song indicated in the comment 150 (i.e. question) is played.

In an arrangement in which the media presentation is a live presentation, and the song has not already played, the navigation model engine 125 can generate a message indicating that the song has not already played. The navigation model engine 125 can communicate the message to the media player 105, which can communicate the message to the comment/navigation interface 145, or the navigation model engine 125 can communicate the message directly to the comment/navigation interface 145. In any case, the comment/navigation interface 145 can present the message to the user. Further, the navigation model engine 125 can instruct the media analyzer 115 to monitor and analyze the media presentation 130 for the song being played. Responsive to detecting the song being played, the media analyzer 115 can communicate, in real time, a message to the navigation model engine 125 indicating that the song has been played, and a time stamp in the media presentation 130 when the song is played. Again, the navigation model engine 125 can communicate, in real time, such message to the media player 105, which can communicate the message to the comment/navigation interface 145, or the navigation model engine 125 can communicate the message directly to the comment/navigation interface 145. The message can include a link to a keyframe of the segment of the media presentation 130 in which the song is played. The comment/navigation interface 145 can present the message to the user.

Further operations of the system 100 are described in the flowcharts and figures that follow.

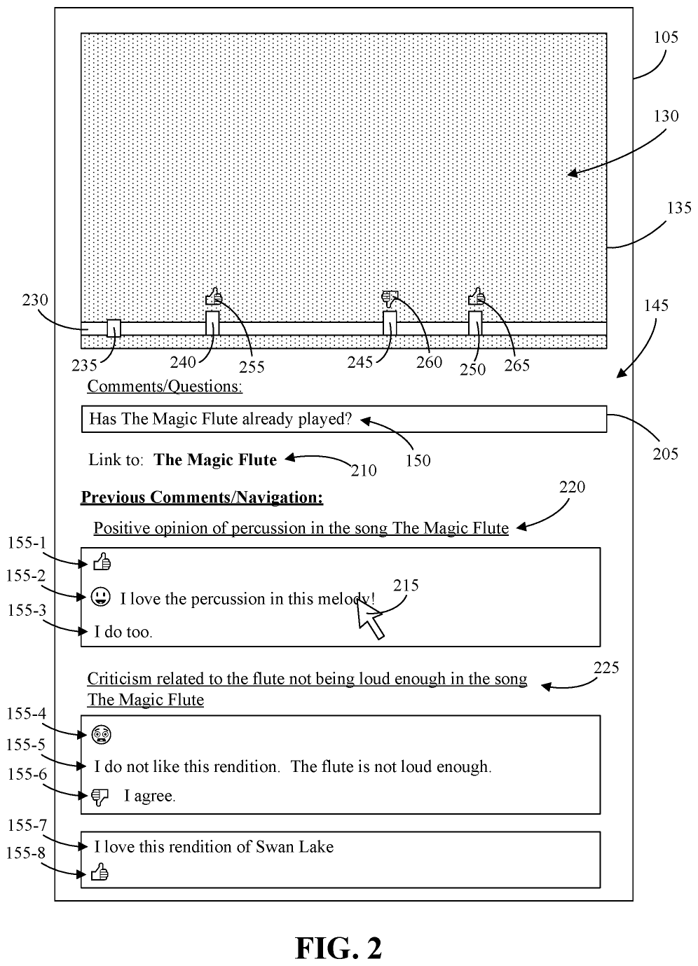

FIG. 2 depicts a view of an example user interface 110 for presenting a media presentation 130 and comments 155 with links to particular segments of the media presentation 130. The user interface 110 can be presented by a client device used by a user, for example on a display of the client device or presented by a projector communicatively linked to the client device. As noted, the user interface 110 can include the media presentation pane 135 in which the media presentation 130 is presented. The user interface 110 also can include the comment/navigation interface 145 via which the user can view previous user comments 155, add new user comments 150, and navigate the media presentation 130.

The comment/navigation interface 145 can include a field 205 in which the user may enter new user comments 150, for example comments and/or questions pertaining to the media presentation 130. In illustration, assume the user is viewing a media presentation in which the user expects the song The Magic Flute to be played, and enters into the field 205 the question “Has The Magic Flute already played?”. In response, the system 100 can analyze the question to determine the nature of the question, for example as previously described. If that song has already been presented in the media presentation 130, the system 100 (FIG. 1) can present a link 210 to the segment of the media presentation 130 in which the song is played, for example as previously described.

The comment/navigation interface 145 also can present previous user comments 155. As noted, each of the previous user comments 155 can be assigned a link that links the comment 155 to a segment of the media presentation 130, for example a keyframe of the segment. Responsive to the user selecting a particular user comment 155, for example using a cursor 215, the system 100 can automatically jump playback of the media presentation 130 to the segment of the media presentation to which the user comment 155 is linked, for example as previously described.

The system 100 can group the previous user comments 155, for example as previously described. In illustration, for the example presented in FIG. 2, the system 100 can group together previous user comments 155-1, 155-2, 155-3 having a positive sentiment toward a particular segment of the media presentation 130, group together previous user comments 155-4, 155-5, 155-6 having a negative sentiment toward the particular segment of the media presentation 130, and group together other comments 155-7, 155-8 having the same sentiment toward another segment of the media presentation 130. New user comments 150 added by the user that pertain to the media presentation 130 can be added to the groups of comments 155 directed to the same segments and expressing the same sentiment as the new user comments 150. Further, comment/navigation interface 145 also can present, for one or more of the groups of user comments 150, 155, one or more sentences 220, 225 indicating reasoning for the user sentiments expressed in the respective groups of user comments 155, for example as previously described. In one arrangement, the navigation model engine 125 can provide links from the sentence(s) 220, 225 to the respective user comments 155-1-155-6 upon which they are based and/or links to the segment of the media presentation 130 to which the sentence(s) pertain.

In one arrangement, the user comments 155-1-155-6 may pertain to the same segment of the media presentation 130, but at least some of the comments 155-1-155-6 may be linked to different keyframes in the segment. The user can select any of the comments 155-1-155-6 to jump playback of the media presentation 130 to the keyframes to which the selected comments 155-1-155-6 are linked. Moreover, the user can initiate the media player 105 (FIG. 1) to sequentially jump to the keyframes to which comments 155-1-155-3, or comments 155-4-155-6, are linked. In illustration, responsive to the user selecting the sentence(s) 220 with the cursor 215, the comment/navigation interface 145 (FIG. 1) can instruct the media player 105 to jump to a keyframe to which the comment 155-1 is linked then, after a particular period of time has elapsed since the user selection, automatically jump to a keyframe to which the comment 155-2 is linked and then, after the particular period of time has again elapsed, automatically jump to a keyframe to which the comment 155-3 is linked. In doing so, the media player can skip keyframes to which the comments 155-4-155-6 in another comment group are linked.

The system 100 also can present a navigation bar 230 presenting a timeline for the presentation. The user can interact with the navigation bar 230 to move playback of the media presentation 130 to a desired portion of the media presentation, for example using a navigation marker 235. The navigation bar 230 can be presented in the media presentation pane 135, for example toward a bottom of the media presentation pane 135 or toward a top of the media presentation pane 135, presented in the user interface 110 above the media presentation pane 135, or presented in the user interface 110 below the media presentation pane 135. In addition, the system 100 can present one or more navigation markers 240, 245, 250 that indicate points of shift between positive and negative sentiments toward the media presentation 130, as previously described. A point can be, for example, at a keyframe at the beginning of a segment. Further, the system 100 can present a respective icon or emoji 255, 260, 265 with each navigation marker 240, 245, 250 to indicate whether the shift indicated by the navigation marker 240, 245, 250 is a shift to a positive sentiment or to a shift to a negative sentiment, as previously described. For instance, the navigation marker 240 and icon/emoji 260 can indicate a shift to a positive sentiment, the navigation marker 245 and icon/emoji 255 can indicate a shift to a negative sentiment, and the navigation marker 250 and icon/emoji 265 can indicate a shift back to a positive sentiment. As noted, the user can select the navigation markers 240-250 or the icons/emojis 255-265 to jump to portions of the media presentation 130 where the shifts in sentiment of the comments 155 are applicable.

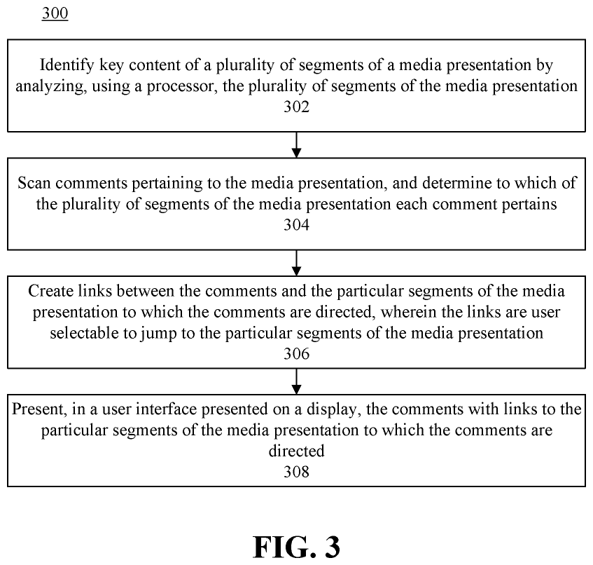

FIG. 3 is a flowchart illustrating an example of a method 300 of linking comments to particular segments of a media presentation 130. Referring to FIGS. 1 and 3, at step 302 the media analyzer 115 can identify key content of a plurality of segments of a media presentation 130 by analyzing, using a processor, the plurality of segments of the media presentation 130. The analyzing can include, for example, performing image analysis of images (e.g., still images and/or video) contained in the segments of the media presentation 130, deriving a computer understandable meaning of spoken utterances contained in the segments of the media presentation 130 by converting the spoken utterances to text using speech recognition on the spoken utterances and deriving a computer understandable meaning of the text by performing NLP and semantic analysis on the text, and/or deriving a computer understandable meaning of text contained in the segments of the media presentation 130 by performing NLP and semantic analysis on the text.

At step 304, the comment analyzer 120 can scan comments 155 pertaining to the media presentation 130, and determine to which of the plurality of segments of the media presentation 130 each comment 155 pertains. In illustration, the comment analyzer 120 can determine to which of the plurality of segments of the media presentation 130 each comment 155 is directed using time stamps indicating when the comments 155 were generated and which segments of the media presentation 130 were presented when the comments 155 were generated. In a further arrangement, the comment analyzer 120 can process text contained in the comments, or text generated using speech recognition on spoken utterances contained in the comments, using NLP and semantic analysis on the text. The comment analyzer 120 can compare results of such analyses to results of the analyses performed on the segments of the media presentation 130 to determine to which segments each of the comments pertains.

At step 306, the navigation model engine 125 can create links between the comments and the particular segments of the media presentation 130 to which the user comments 155 are directed, wherein the links are user selectable to jump to the particular segments of the media presentation 130. In illustration, the media analyzer 115 can process the media presentation 130 to identify key frames in the media presentation 130, each keyframe marking a respective segment of the media presentation 130. The navigation model engine 125 can process results of such analysis, as well as results of the analysis performed by the comment analyzer 120, to build a media navigation model 160 for the media presentation 130 based on the keyframes. In one aspect, at least one of the keyframes can be associated with a plurality of the user comments 155 deemed to be similar by the comment analyzer 120. The links between the user comments 155 and the particular segments of the media presentation 130 can be defined by the media navigation model 160 and link to the keyframes.

At step 308, the comment/navigation interface 145 can present, in a user interface 110 presented on a display, the comments 155 with links to the particular segments of the media presentation 130 to which the comments 155 are directed, for example as previously described. As noted, the comment analyzer 120 can determine a sentiment expressed by each of the plurality of comments by analyzing each of the plurality of comments. In the media navigation model 160, the navigation model engine 125 can group, into respective comment groups, comments deemed to exhibit similar sentiments toward the media presentation 130. The comment/navigation interface 145 can present the comment groups in the user interface 110. In one aspect, one or more of the comments can include one or more emojis or emoticons, and the comment analyzer 120 can determine the sentiment expressed by the comments by determining the meaning of the emojis or emoticons. As further noted, the comment/navigation interface 145 can configure the user interface 110 to enable the user to navigate to a plurality of the keyframes associated with the plurality of comments in a comment group or to skip the plurality of the keyframes associated with the comments in a comment group.

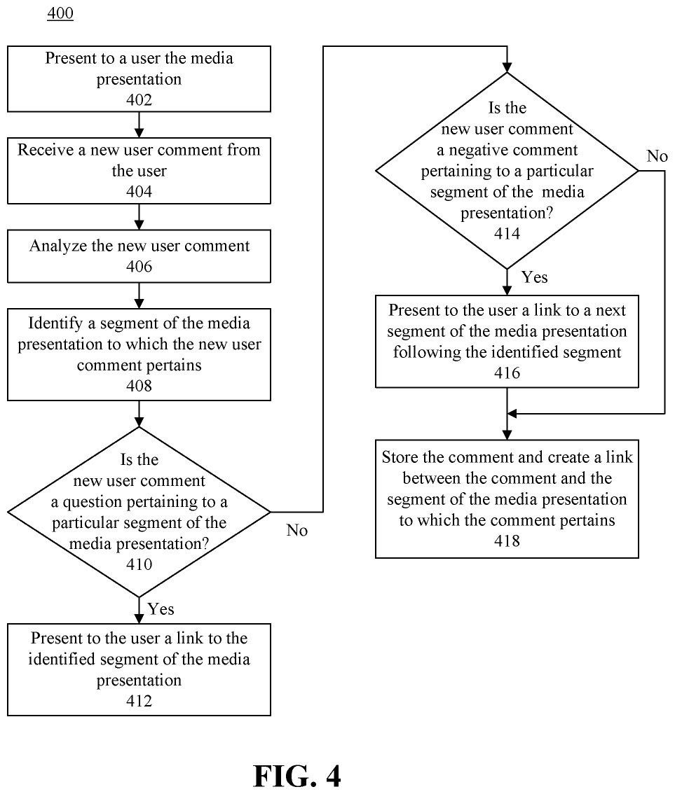

FIG. 4 is a flowchart illustrating an example of processing of a new user comment 150 pertaining to a media presentation 130. At step 402, the media player 105 can present the media presentation 130 to the user in a user interface 110. At step 404, the comment/navigation interface 145 can receive a new user comment 150 from the user that pertains to the media presentation 130. At step 406, the comment analyzer 120 can analyze the comment. For example, the comment analyzer 120 can analyze text or spoken utterance(s) contained in the new user comment 150 using natural language processing and, based on the analyzing, determine a particular segment of the media presentation to which the new comment pertains, for example as previously described.

Referring to decision box 410, the comment analyzer 120 can determine whether the new user comment 150 is a question pertaining to a particular segment of the media presentation 130. If so, at step 412 the comment/navigation interface 145 can present to the user a link to the identified segment of the media presentation 130. Otherwise, the process can proceed to decision box 414.

At decision box 414, the comment analyzer 120 can determine whether the new user comment 150 is a negative comment pertaining to a particular segment of the presentation. If not, the process can proceed to step 418. If the comment is a negative comment, the comment/navigation interface 145 can present to the user a link to a next segment of the media presentation 130 following the identified segment, and the process can proceed to step 418. At step 418, the navigation model engine 125 can store the comment and create, in the media navigation model 160, a link between the comment and the segment of the media presentation 130 to which the comment pertains. For example, the link can be to a keyframe of the segment. Further, the navigation model engine 125 can store in the media navigation model 160 information identifying the sentiment of the new user comment 150 toward the segment, which can be determined by the comment analyzer 120.

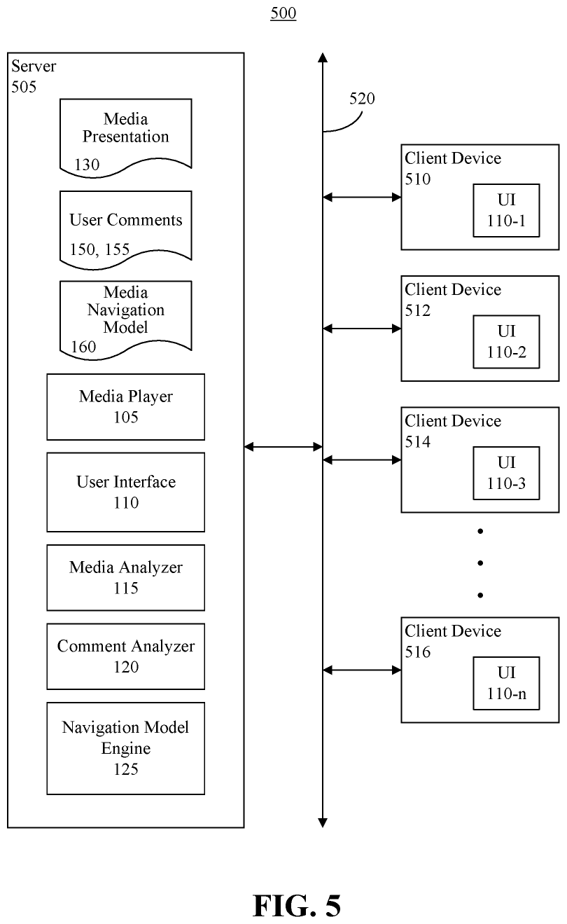

FIG. 5 is a block diagram illustrating an example of a media presentation environment (hereinafter “environment”) 500. The environment 500 can include a server 505 (or a plurality of communicatively linked servers) and a plurality of client devices 510, 512, 514, 516. The client devices 510-516 can communicatively link to the server 505 via a communication network 520. The communication network 520 is the medium used to provide communications links between various devices and data processing systems connected together within the environment 500. The communication network 520 may include connections, such as wire, wireless communication links, or fiber optic cables. The communication network 520 can be implemented as, or include, any of a variety of different communication technologies such as a wide area network (WAN), a local area network (LAN), a wireless network, a mobile network, a Virtual Private Network (VPN), the Internet, the Public Switched Telephone Network (PSTN), or similar technologies.

The server 505 can be configured to stream and/or download the media presentation 130, as well as other media presentations, to the client devices 510-516. For example, a server 505 can be a social networking system server, a media sharing server, or the like. The server 505 can store the media presentation 130, previous user comments 155, new user comments 150 as the new user comments 150 are received, and the media navigation model 160. In another arrangement, one or more of the media presentation 130, user comments 150, 155 and media navigation model 160 can be stored on one or more other systems to which the server 505 is/are communicatively linked, for example data storage systems.

The server 505 can include the media analyzer 115, the comment analyzer 120 and the navigation model engine 125. In one arrangement, the server also can include the media player 105 and the user interface 110. In such an arrangement, various instances 110-1, 110-2, 110-3, 110-n of the user interface 110 and, optionally, various instances of the media player 105 (not shown), can be communicated to the respective client devices 510-516 responsive to the client devices 510-516 requesting access to the media presentation 130. The instances 110-1-110-n of the user interface 110 and the instances of the media player 105, for example, can be presented in a web browser on each of the respective client devices 510-516. In another arrangement, the client devices 510-516 each can execute a respective copy and/or version of an application, for example a mobile application, that includes the media player 105 and the user interface 110. Regardless, the server can stream and/or download the media presentation 130 to the client devices 510-516 upon request and the various components can perform the functionality previously described with respect to FIGS. 1-4.

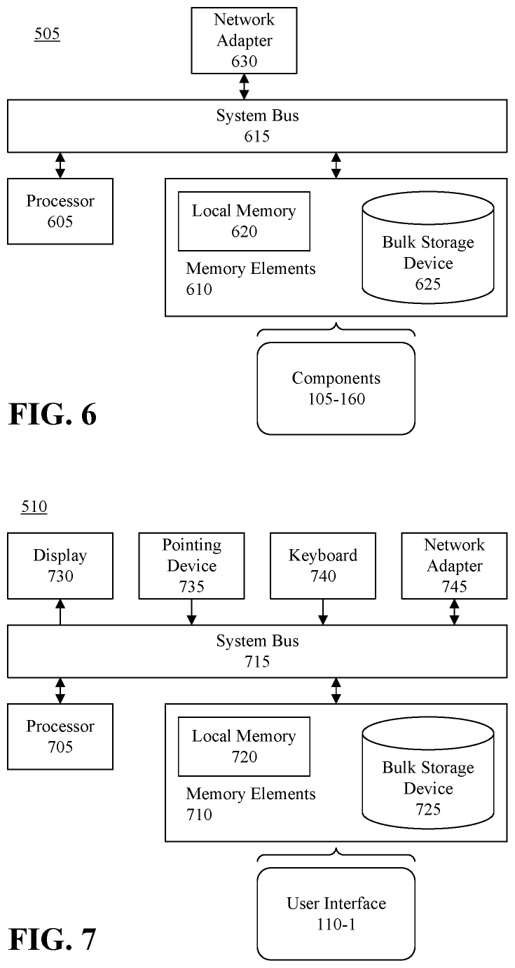

FIG. 6 is a block diagram illustrating example architecture for the server 505. The server 505 can include at least one processor 605 (e.g., a central processing unit) coupled to memory elements 610 through a system bus 615 or other suitable circuitry. As such, the server 505 can store program code within the memory elements 610. The processor 605 can execute the program code accessed from the memory elements 610 via the system bus 615. It should be appreciated that the server 505 can be implemented in the form of any system including a processor and memory that is capable of performing the functions and/or operations described within this specification. For example, the server 505 can be implemented as a single server or a plurality of communicatively linked servers.

The memory elements 610 can include one or more physical memory devices such as, for example, local memory 620 and one or more bulk storage devices 625. Local memory 620 refers to random access memory (RAM) or other non-persistent memory device(s) generally used during actual execution of the program code. The bulk storage device(s) 625 can be implemented as a hard disk drive (HDD), solid state drive (SSD), or other persistent data storage device. The server 505 also can include one or more cache memories (not shown) that provide temporary storage of at least some program code in order to reduce the number of times program code must be retrieved from the bulk storage device 625 during execution.

One or more network adapters 630 can be coupled to server 505 to enable the server 505 to become coupled to other systems, computer systems, and/or remote storage devices through intervening private or public networks. Modems, cable modems, transceivers, and Ethernet cards are examples of different types of network adapters 630 that can be used with the server 505.

As pictured in FIG. 6, the memory elements 610 can store the components of the server 505, namely an operating system (not shown), the media analyzer 115, the comment analyzer 120, the navigation model engine 125 and, optionally, the media player 105, the user interface 110, the media presentation 130, the user comments 150, 155 and the media navigation model 160. Being implemented in the form of executable program code, these components of the 105-160 can be executed by the server 505 and, as such, can be considered part of the server 505. Moreover, the components of the 105-160 are functional data structures that impart functionality when employed as part of the server 505.

FIG. 7 is a block diagram illustrating example architecture for the client device 510. The client devices 112-116 can be configured in a similar manner. The client device 510 can include at least one processor 705 (e.g., a central processing unit) coupled to memory elements 710 through a system bus 715 or other suitable circuitry. As such, the client device 510 can store program code within the memory elements 710. The processor 705 can execute the program code accessed from the memory elements 710 via the system bus 715. It should be appreciated that the client device 510 can be implemented in the form of any system including a processor and memory that is capable of performing the functions and/or operations described within this specification. For example, the client device 510 can be implemented as a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television, etc.

The memory elements 710 can include one or more physical memory devices such as, for example, local memory 720 and one or more bulk storage devices 725. The client device 510 also can include one or more cache memories (not shown) that provide temporary storage of at least some program code in order to reduce the number of times program code must be retrieved from the bulk storage device 725 during execution.

Input/output (I/O) devices such as a display 730, a pointing device 735 and, optionally, a keyboard 740 can be coupled to the client device 510. The I/O devices can be coupled to the client device 510 either directly or through intervening I/O controllers. For example, the display 730 can be coupled to the client device 510 via a graphics processing unit (GPU), which may be a component of the processor 705 or a discrete device. One or more network adapters 745 also can be coupled to client device 510 to enable the client device 510 to become coupled to other systems, computer systems, remote printers, and/or remote storage devices through intervening private or public networks. Modems, cable modems, transceivers, and Ethernet cards are examples of different types of network adapters 745 that can be used with the client device 510.

As pictured in FIG. 7, the memory elements 710 can store the components of the client device, namely an operating system (not shown) and the user interface 110-1. The user interface 110-1 can be presented on the display 730. The user interface 110-1 can be stored temporarily to the memory elements 710 while the media presentation 130 is being accessed, or the user interface 110-1 can be persisted to the memory elements 710, for example in an arrangement in which the user interface 110-1 is a component of an application (e.g., a mobile application) stored to the memory elements 710. In such an arrangement, the client device 510 also can store the media player 105. Being implemented in the form of executable program code, these components 110-1, 105 of the client device 510 can be executed by the client device 510 and, as such, can be considered part of the client device 510. Moreover, these components 110-1, 105 are functional data structures that impart functionality when employed as part of the client device 510.

The following use cases may be beneficial for understanding the present arrangements.

Use Case #1

Assume that the server 505 is scheduled to stream a media presentation 130, such as a concert, live in London, UK at 9 PM local time, which is 3:00 PM in the user's time zone. The server 505 (e.g., via the comment/navigation interface 145) can notify the user that the server is going to start, or has started, a live stream of the concert. The user desires to view the live stream, but is currently occupied with another matter. When the user accesses the live stream from the server, via the comment/navigation interface 145, the user can query the server 505 to ask if a particular song has already played. If the song has already played, the server 505 can respond by presenting in the comment/navigation interface 145 a link to the segment in the media presentation 130 where the song is played, for example a link to a keyframe at the start of the song. If the song has not yet played, via the comment/navigation interface 145, the server can present to the user, via the comment/navigation interface 145, a message indicating the song has not yet played. When the song does play, the server can notify the user, via the comment/navigation interface 145, that the song is being played and provide the user a link to the segment in which the song is being played. In another arrangement, the server 505 can be configured to communicate to the user a message, for example via text, e-mail or another form of electronic communication, indicating when the song is being played and providing a URL to the media presentation 130 with a link to the segment where the song is being played.

Use Case #2

Assume the user is viewing the media presentation 130, and the media presentation 130 pertains to a criminal trial. Previous user comments 155 containing the text “guilty” along with a mad emoji may have been provided by other users and presented to the user in the comment/navigation interface 145. The comments 155 can be color coded in the same color since they are similar in nature and express the same sentiment. The user can select any of the comments 155 to jump to the corresponding segment in the media presentation 130 in which a guilty verdict was read.

Use Case #3

A first user provides a comment 155 on a media presentation 130 which is a movie half-way through a terrible scene. The navigation model engine 125 can create a scene/forward navigation marker 240 at a keyframe located half-way through the scene. A second user can access the same movie, and may want to quickly view cool parts of the movie. The second user can use the navigation bar 230 or another navigation element to quickly jump through the movie. The media player 105 can jump playback of the movie to the location in the movie indicated by the navigation marker 240 (e.g., half-way through the scene), or to the beginning of the scene.

Use Case #4

Assume the following: A first user provides a comment 155 “This part is really bad.” A second user provides a comment 155 “Yeah, why would he think the numbers are low when they are higher than last week.” A third user provides a comment 155 “I don't think it's too bad, just a different perspective overall that week to week.” The navigation model engine 125 can link each of the user comments 155 to the segment of the presentation to which they pertain, and present the comments 155 to a fourth user to whom the media presentation 130 is being presented. Further, the navigation model engine 125 can generate one or more sentences indicating reasoning for the sentiment of the user comments 155, and add such sentence(s) to the media navigation model 160. The comment/navigation interface 145 can present the sentence(s) to the user with links to one or more of the user comments 155 provided by the first, second and third users.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart(s) and block diagram(s) in the Figures illustrate the architecture, functionality, and operation of possible implementations of systems, methods, and computer program products according to various embodiments of the present invention. In this regard, each block in the flowchart(s) or block diagram(s) may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
identifying key content of a plurality of segments of a media presentation by analyzing the plurality of segments of the media presentation;
scanning comments pertaining to the media presentation, and determining to which of the plurality of segments of the media presentation each comment pertains;
creating, using a processor, links between the comments and particular segments of the media presentation to which the comments are directed, wherein the links are user selectable to jump to the particular segments of the media presentation; and
presenting, in a user interface presented on a display, the comments with the links to the particular segments of the media presentation to which the comments are directed.

2. The method of claim 1, further comprising:
identifying keyframes in the media presentation, each keyframe marking a respective segment of the media presentation; and
building a navigation model for the media presentation based on the keyframes, wherein at least one of the keyframes is associated with a plurality of comments deemed to be similar, wherein the links between the comments and the particular segments of the media presentation are defined by the navigation model and link to the keyframes.

3. The method of claim 2, further comprising:
determining a sentiment expressed by each of the plurality of comments by analyzing each of the plurality of comments;
grouping, into a comment group, a portion of the plurality of comments deemed to exhibit a similar sentiment toward the media presentation; and
presenting the comment group in the user interface.

4. The method of claim 3, wherein at least one of the plurality of comments comprises at least one emoji or emoticon, the method further comprising:
determining, for the at least one of the plurality of comments, the sentiment expressed by the comment by determining a meaning of the emoji or emoticon.

5. The method of claim 3, further comprising:
configuring the user interface to enable the user to navigate to a plurality of the keyframes associated with the plurality of comments in the comment group or to skip the plurality of the keyframes associated with the comments in the comment group.

6. The method of claim 1, further comprising:
receiving from a user a new comment comprising text or a spoken utterance;
analyzing the text or spoken utterance using natural language processing and, based on the analyzing, determining a particular segment of the media presentation to which the new comment pertains; and
responsive to the analyzing, presenting to the user a link to the particular segment of the media presentation to which the new comment pertains.

7. The method of claim 1, wherein the analyzing the plurality of the segments of the media presentation comprises:
performing image analysis of at least one image contained in at least one of the plurality of the segments of the media presentation.

8. The method of claim 1, wherein the analyzing the plurality of the segments of the media presentation comprises:
deriving a computer understandable meaning of spoken utterances contained in at least one of the plurality of the segments of the media presentation by converting the spoken utterances to text using speech recognition on the spoken utterances and deriving a computer understandable meaning of the text by performing natural language processing and semantic analysis on the text.

9. The method of claim 1, wherein the analyzing the plurality of the segments of the media presentation comprises:
deriving a computer understandable meaning of text contained in at least one of the plurality of the segments of the media presentation by performing natural language natural language processing and semantic analysis on the text.

10. A system, comprising:
a processor programmed to initiate executable operations comprising:
identifying key content of a plurality of segments of a media presentation by analyzing the plurality of segments of the media presentation;
scanning comments pertaining to the media presentation, and determining to which of the plurality of segments of the media presentation each comment pertains;
creating links between the comments and particular segments of the media presentation to which the comments are directed, wherein the links are user selectable to jump to the particular segments of the media presentation; and
presenting, in a user interface presented on a display, the comments with the links to the particular segments of the media presentation to which the comments are directed.

11. The system of claim 10, the executable operations further comprising:
identifying keyframes in the media presentation, each keyframe marking a respective segment of the media presentation; and
building a navigation model for the media presentation based on the keyframes, wherein at least one of the keyframes is associated with a plurality of comments deemed to be similar, wherein the links between the comments and the particular segments of the media presentation are defined by the navigation model and link to the keyframes.

12. The system of claim 11, the executable operations further comprising:
determining a sentiment expressed by each of the plurality of comments by analyzing each of the plurality of comments;
grouping, into a comment group, a portion of the plurality of comments deemed to exhibit a similar sentiment toward the media presentation; and
presenting the comment group in the user interface.

13. The system of claim 12, wherein at least one of the plurality of comments comprises at least one emoji or emoticon, the executable operations further comprising:
determining, for the at least one of the plurality of comments, the sentiment expressed by the comment by determining a meaning of the emoji or emoticon.

14. The system of claim 12, the executable operations further comprising:
configuring the user interface to enable the user to navigate to a plurality of the keyframes associated with the plurality of comments in the comment group or to skip the plurality of the keyframes associated with the comments in the comment group.

15. The system of claim 10, the executable operations further comprising:
receiving from a user a new comment comprising text or a spoken utterance;
analyzing the text or spoken utterance using natural language processing and, based on the analyzing, determining a particular segment of the media presentation to which the new comment pertains; and
responsive to the analyzing, presenting to the user a link to the particular segment of the media presentation to which the new comment pertains.

16. The system of claim 10, wherein the analyzing the plurality of the segments of the media presentation comprises:
performing image analysis of at least one image contained in at least one of the plurality of the segments of the media presentation.

17. The system of claim 10, wherein the analyzing the plurality of the segments of the media presentation comprises:
deriving a computer understandable meaning of spoken utterances contained in at least one of the plurality of the segments of the media presentation by converting the spoken utterances to text using speech recognition on the spoken utterances and deriving a computer understandable meaning of the text by performing natural language processing and semantic analysis on the text.

18. The system of claim 10, wherein the analyzing the plurality of the segments of the media presentation comprises:
deriving a computer understandable meaning of text contained in at least one of the plurality of the segments of the media presentation by performing natural language natural language processing and semantic analysis on the text.

19. A computer program product, comprising:
a computer readable storage medium having program code stored thereon, the program code executable by a data processing system to initiate operations including:
identifying key content of a plurality of segments of a media presentation by analyzing the plurality of segments of the media presentation;
scanning comments pertaining to the media presentation, and determining to which of the plurality of segments of the media presentation each comment pertains;
creating links between the comments and particular segments of the media presentation to which the comments are directed, wherein the links are user selectable to jump to the particular segments of the media presentation; and
presenting, in a user interface presented on a display, the comments with the links to the particular segments of the media presentation to which the comments are directed.

20. The computer program product of claim 19, wherein the program code is executable by the data processing system to initiate operations further comprising:
identifying keyframes in the media presentation, each keyframe marking a respective segment of the media presentation; and
building a navigation model for the media presentation based on the keyframes, wherein at least one of the keyframes is associated with a plurality of comments deemed to be similar, wherein the links between the comments and the particular segments of the media presentation are defined by the navigation model and link to the keyframes.
